(19) United States
(12) Patent Application Publication
(10) Pub. No.: US 2020/0028218 A1
(43) Pub. Date: Jan. 23, 2020

(54) Wireless Battery System

(71) Applicants: HITACHI, LTD., Tokyo (JP); Vehicle Energy Japan Inc., Hitachinaka-shi, Ibaraki (JP)

(72) Inventors: Takanori YAMAZOE, Tokyo (JP); Kei SAKABE, Tokyo (JP)

(21) Appl. No.: 16/477,418

(22) PCT Filed: Dec. 6, 2017
(86) PCT No.: PCT/JP2017/043740

§ 371 Date: Jul. 11, 2019

(30) Foreign Application Priority Data
Jan. 12, 2017 (JP) 2017-003020

(51) Int. Cl. H01M 10/46; H02J 7/00

(52) U.S. Cl. CPC H01M 10/46; H02J 2007/0096; H02J 2007/0095; H02J 7/0021

(57) ABSTRACT

A wireless battery system is provided in which wireless communication errors are reduced and CC's power consumption is less. A wireless battery system including a plurality of cell controllers connected to battery cells and a battery controller which is connected by radio with the plurality of cell controllers, wherein the battery controller and the plurality of cell controllers are connected by radio in a daisy chain manner and the plurality of cell controllers are controlled by passive reception. This makes it possible to provide a wireless battery system in which wireless communication errors are reduced and CC's power consumption is less.

### TECHNICAL FIELD

The present invention relates to a wireless battery system.

### BACKGROUND ART

As greatly increasing attention is currently drawn to global environmental issues, it is required in every situation to reduce the emission of carbon dioxide gas for prevention of global warming, and motor vehicles with gasoline engines that are a major source of carbon dioxide gas emission are beginning to be superseded by hybrid electric vehicles or electric vehicles among others.

A large secondary battery, which is a typical power source for powering hybrid electric vehicles or electric vehicles, needs to have a high output and a large capacity and, therefore, a storage battery module that constitutes it is internally configured with plural batteries (hereinafter referred to as cells) in series-parallel connection.

Also, a lithium-ion battery which is a secondary battery needs proper care in using the secondary battery including prevention of charging with high voltage and prevention of performance deterioration because of overdischarge. Hence, a storage battery module that is mounted in a hybrid electric vehicle or an electric vehicle has functions for detecting voltage, current, temperature, etc. which are indicative of battery state. FIG. 1 depicts a structure of a storage battery module that is mounted in a hybrid electric vehicle or an electric vehicle. As depicted in FIG. 1, plural cells are connected to a cell controller (hereinafter referred to as CC) and the CC takes measurements of the states of the cells. Additionally, plural CCs are connected to a battery controller (hereinafter referred to as BC) and the BC acquires the states of the cells from the CCs. Moreover, the BC computes charge condition (SOC: State of Charge) and battery deterioration condition (SOH: State of Health) and notifies an upper-level hybrid controller or the like of computational results.

Although the BC and CCs are wired for communication in FIG. 1, PTL 1 and PTL 2 suggest that changing wired connection between the BC and CCs to wireless connection makes it possible to dispense with wiring cost and insulation circuits for countermeasures against high voltage, so that cost can be reduced. Also, PTL 2 suggests that performing one-to-one wireless communication of information including battery state between adjacently placed battery modules via wireless communication antennas makes it possible to avoid faulty communication due to transmission signal interference.

### CITATION LIST

### Patent Literature

PTL 1: Japanese Patent Application Laid-Open No. 2005-135762

PTL 2: Japanese Patent Application Laid-Open No. 2012-222913

### SUMMARY OF INVENTION

### Technical Problem

In PTL 1, since wireless communication is fundamentally performed using wireless tags on the CCs, communication distance is short and there is a possibility that communication errors tend to occur when one BC attempts to communication with plural CCs. In addition, in PTL 2, communication errors can be reduced because of communication between adjacent CCs without using wireless tags, but it is considered that power consumption of CCs is large when they transmit and receive.

Therefore, an object of the present invention is to provide a wireless battery system in which wireless communication errors are reduced and CC's power consumption is less. The above and other objects and novel features of the present invention will be apparent from the description in the present specification and the accompanying drawings.

### Solution to Problem

A feature of the present invention to solve the above-noted problem is, for example, as follows.

A wireless battery system comprising a plurality of cell controllers connected to battery cells and a battery controller which is connected by radio with the plurality of cell controllers, wherein the battery controller and the plurality of cell controllers are connected by radio in a daisy chain manner and the plurality of cell controllers are controlled by passive reception.

### Advantageous Effects of Invention

According to the present invention, it is possible to provide a wireless battery system in which wireless communication errors are reduced and CC's power consumption is less.

### BRIEF DESCRIPTION OF DRAWINGS

FIG. 1 is a structural diagram of a storage battery module for in-vehicle use.

FIG. 2 is a structural diagram of a wireless battery system.

FIG. 3 is a diagram representing the contents of transmission data by CC.

FIG. 4 is a circuit structure diagram of a CC.

FIG. 5 is a circuit structure diagram of a BC.

FIG. 6 is a wireless circuit diagram in the BC and CC.

FIG. 7 is a diagram in which a CC is installed to a battery as a battery cell.

FIG. 8 is a view of the CC from overhead of the battery cell.

FIG. 9 is a diagram of arrangement of plural battery cells to which a CC is installed and BC antennas.

FIG. 10 is an arrangement diagram of a wireless battery system for conventional one-to-N communication.

FIG. 11 is an example of a radiation pattern of a dipole antenna

FIG. 12 is a correlation diagram between S/N and BER when ASK demodulation is performed.

FIG. 13A is a structural diagram of a wireless battery system.

FIG. 13B is a structural diagram of a wireless battery system.

FIG. 14A is a diagram representing the contents of transmission data by CC in FIG. 13A.

FIG. 14B is a diagram representing the contents of transmission data by CC in FIG. 13B.

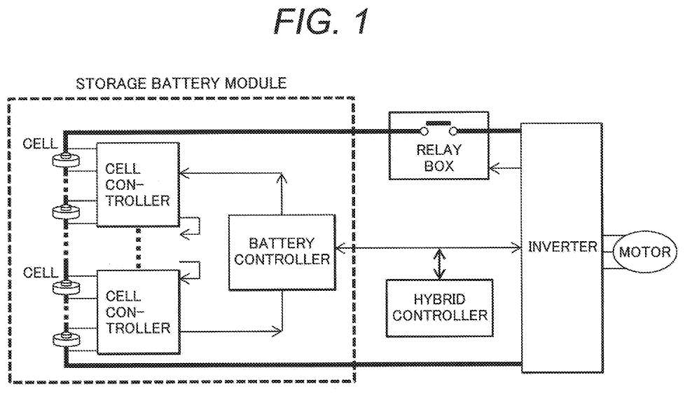

### DESCRIPTION OF EMBODIMENTS

In the following, embodiments of the present invention will be described using the drawings among others. The following descriptions set forth specific examples of implementation of the present invention and the present invention is not limited to these descriptions, and various alterations and modifications may be made thereto by those skilled in the art within the scope of technical idea disclosed herein. In addition, in all the drawings to explain the present invention, those having a same function are assigned a same reference designator and duplicated description thereof may be omitted.

### EXAMPLE 1

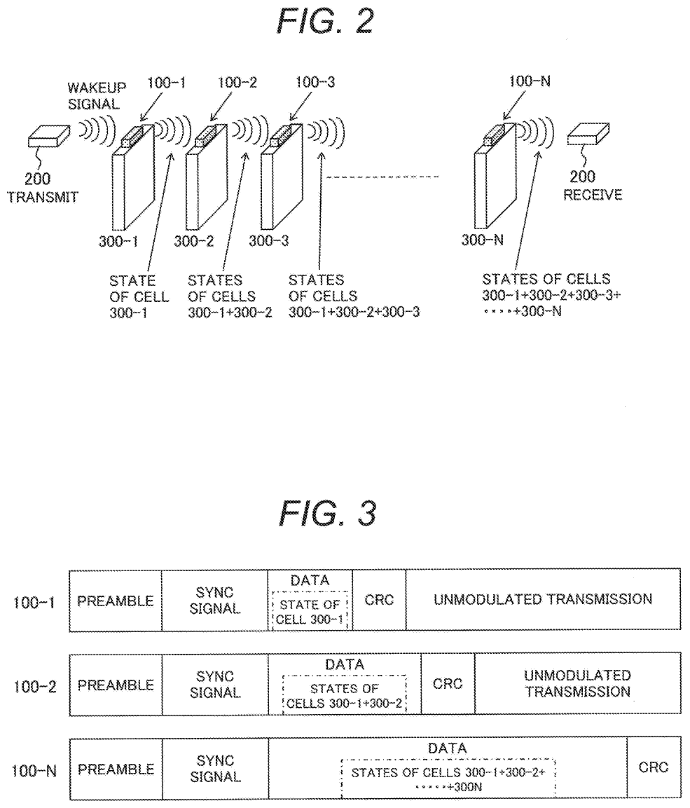

A structural diagram of a wireless battery system pertaining to one embodiment of the present invention is depicted in FIG. 2. A fundamental structure is such that one BC 200 (battery controller) and plural CCs 100 (cell controllers) establish a network and perform communication using radio packets. The CCs 100 are mounted for each battery cell or for every plural battery cells and operate with power of the battery cells. The CCs 100 may operate using radio wave power like IC cards or RFIDs. When the CCs are made to operate with radio wave power, the radio wave power attenuates by communication distance and, therefore, their communication distance depends on power and their communication distance falls within a range of several centimeters (cm) or several tens of cm. On the other hand, when the CCs 100 are made to operate with power of the battery cells, their communication distance depends on their transmitting/receiving characteristics and can be on the order of several meters. In addition, each battery cell 300 and each CC 100 are placed proximate to each other.

The BC 200 periodically transmits a wakeup signal to a CC 100-1 to check for the battery state (including voltage, temperature, etc.) of each battery cell 300. When passively receiving the wakeup signal, the CC 100-1 takes measurements of the battery state (including voltage, temperature, etc.) of a cell 300-1 and transmits the measurements to a CC 100-2. At the same time, the CC 100-1 may transmit an ACK signal to the BC 200 to notify that it received the wakeup signal.

Upon passively receiving a transmission signal from the CC 100-1, the CC 100-2 takes measurements of the battery state of a battery cell 300-2 and transmits the state of the battery cell 300-2 in addition to the data (the battery state of the cell 300-1) received from the CC 100-1 to a CC 100-3. At the same time, the CC 100-2 may transmit an ACK signal to the CC100-1 to notify that it received the data. In this way, the BC 200 and the respective CCs 100 perform wireless communication in a daisy chain manner and the BC 200 is enabled to passively receive the battery states of battery cells 300 measured by all CCs 100.

As described above, the plural CCs 100 in FIG. 2 include a CC 100-1 (first cell controller), CC 100-2 (second cell controller), and CC 100-3 (third cell controller) and, when each CC 100 passively receives a wakeup signal from the BC 200 or the battery state of a battery cell 300 from another CC 100, it returns a reply signal indicating that it received incoming data to the BC 200 or another CC 100. For example, the CC 100-2 transmits the battery state of a battery cell 300 that is connected to the CC 100-2 to the CC 100-3 in addition to the data received from the CC 100-1.

In this process, more data is transmitted by the CC 100-2 than data that is transmitted by the CC 100-1 and even more data is transmitted by the CC 100-3 than the data that is transmitted by the CC 100-2 and time for transmission becomes longer accordingly. A difference in the time for transmission by each CC 100 makes a difference in power consumption of each CC 100 and makes a difference in SOC (State of Charge) among the battery cells 300. Therefore, to equalize the time for transmission by each CC 100, an interval of unmodulated transmission for which no data is transmitted is provided, as in FIG. 3, so that the time for transmission will become equal. FIG. 3 is a diagram representing the contents of transmission data by CC pertaining to one embodiment of the present invention.

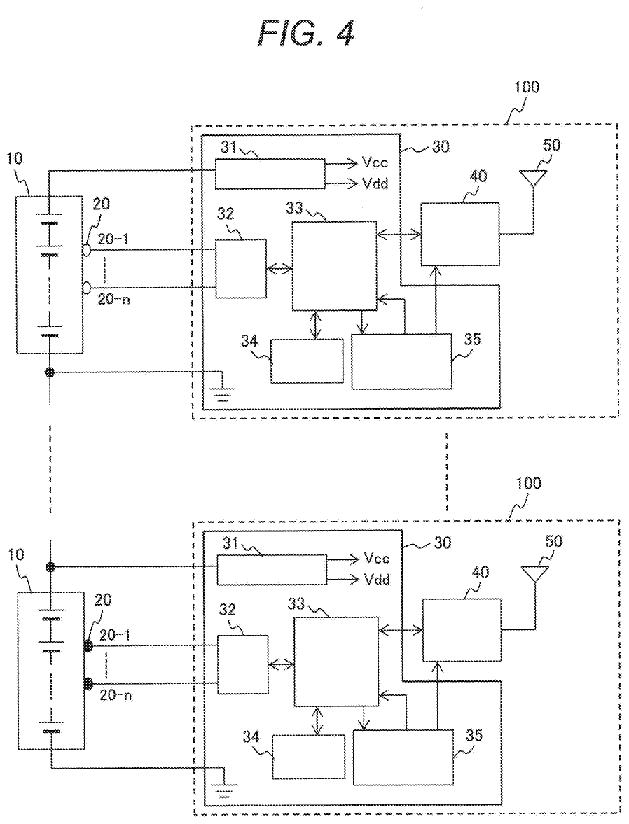

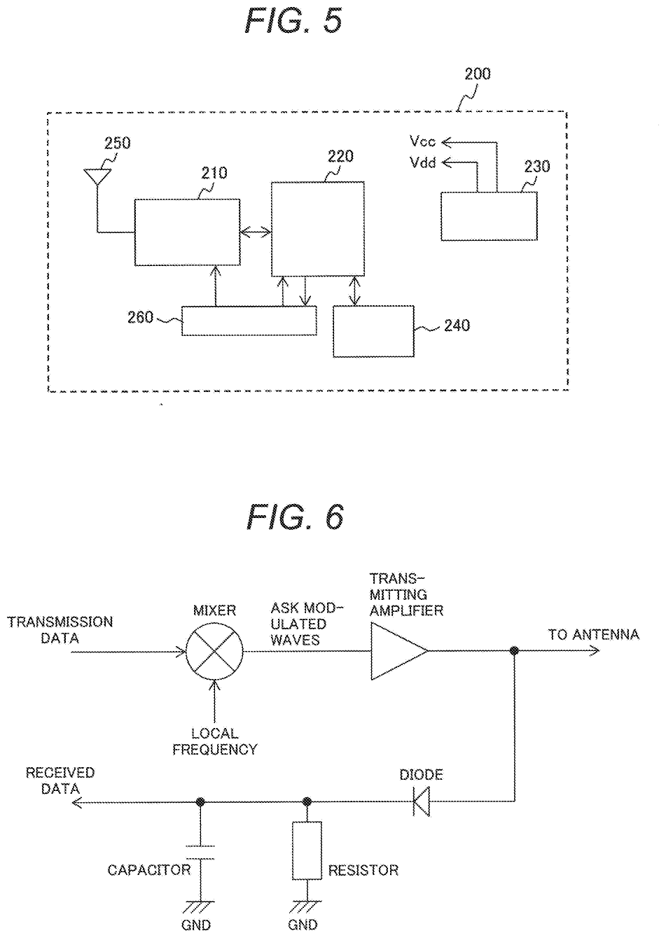

FIG. 4 depicts a circuit structure diagram of a CC pertaining to one embodiment of the present invention and FIG. 5 depicts a circuit structure diagram of a BC pertaining to one embodiment of the present invention. Also, FIG. 6 depicts a wireless circuit structure diagram of the BC and CC pertaining to one embodiment of the present invention.

First, the circuit structure of a CC 100 is described with FIG. 4. Each CC is installed to a battery cell bank 10 and takes measurements of the battery states of battery cells 300. The battery cell bank 10 includes one or plural battery cells 300. The CC 100 is internally comprised of a sensor 20 which takes measurements of the battery states of battery cells 300, a processing unit 30 which acquires and processes state information of the battery cells 300, a wireless circuit 40, and an antenna 50 for input/output of radio waves. The sensor 20 includes one or plural units.

The processing unit 30 is comprised of a power supply circuit 31 which receives power from the battery cell bank 10 and generates an operating voltage, an A/D converter 32 (ADC) which converts analog values measured by the sensor 20 to digital data, a logic circuit 33 which outputs data after being converted by the A/D converter 32 to the wireless circuit, a storage device 34 (memory) which stores individual identification information (unique ID) and others, and a clock generator 35. The clock generator 35 is capable of oscillating a highspeed clock ranging from several MHz to several hundred MHz approximately and a low-speed clock of on the order of several tens of kHz, while switching between these clocks. In addition, the logic circuit 33 is capable of performing the following: turning on/off of a subset of circuits within the wireless circuit 40 and the logic circuit 33 according to the presence or absence of wireless signal reception and condition, switching between clock frequencies in the clock generator 35, and read/write from/to the storage device 34.

Then, the circuit structure of the BC is described with FIG. 5. The BC 200 is comprised of a wireless circuit 210, a logic circuit 220, a power supply circuit 230 including a battery, a clock generator 260, and one or more antennas 250. The power supply circuit 230 has a built-in battery in FIG. 5, but may be supplied with power from outside.

FIG. 6 depicts the wireless circuit in the BC and CC. For transmission, a multiplier circuit (mixer) generates ASK modulated waves according to data to transmit and a transmitting amplifier amplifies the waves and outputs them to the antenna. On the other hand, for reception, envelope demodulation (passive reception) of ASK modulated waves received by the antenna is performed by passive components, namely, a diode, a resistor, and a capacitor. In other words, the plural CCs 100 are controlled by passive reception. This makes it possible to approximate the power consumption of the wireless circuit to zero when waiting for reception and when receiving.

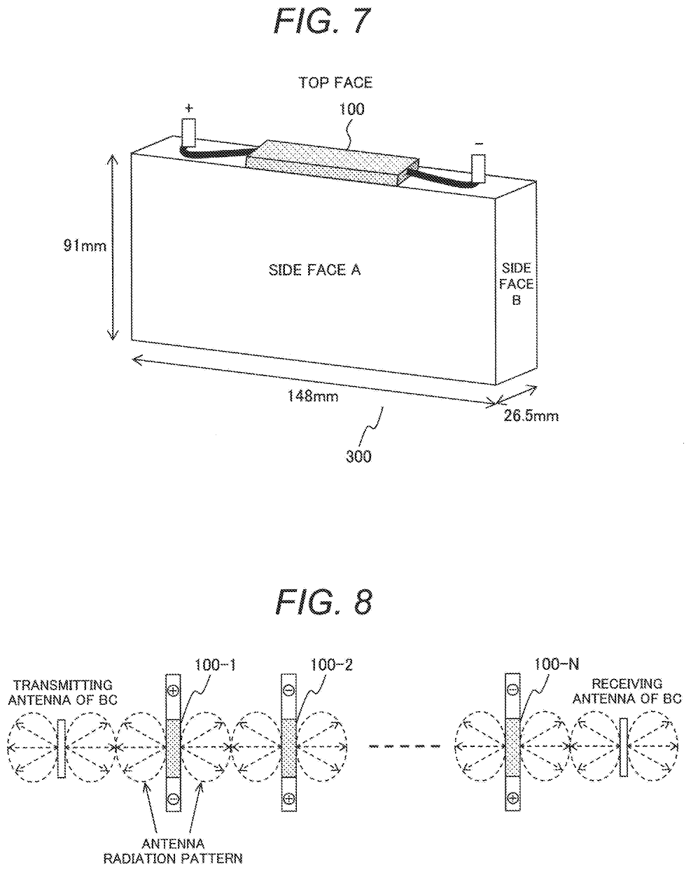

FIG. 7 depicts a diagram in which a CC is installed to a rectangular battery cell. FIG. 8 is a view of the CC from overhead of the rectangular battery cell. By forming an antenna radiation pattern of the BC 200 and the CCs 100 so that there is a strong radiation from side faces A, it is possible to provide stronger radio intensity toward CCs 100 on both sides and communication errors can be reduced. In other words, the CCs 100 and BC 200 each have an antenna for transmitting and receiving data and the antenna of any CC 100 of the plural CCs 100 has directionality that is made stronger toward the antenna of the CCs 100 or the BC 200 from which to receive data or to which to transmit; thereby, it is possible to provide a stronger radio intensity toward CCs 100 on both sides and communication errors can be reduced.

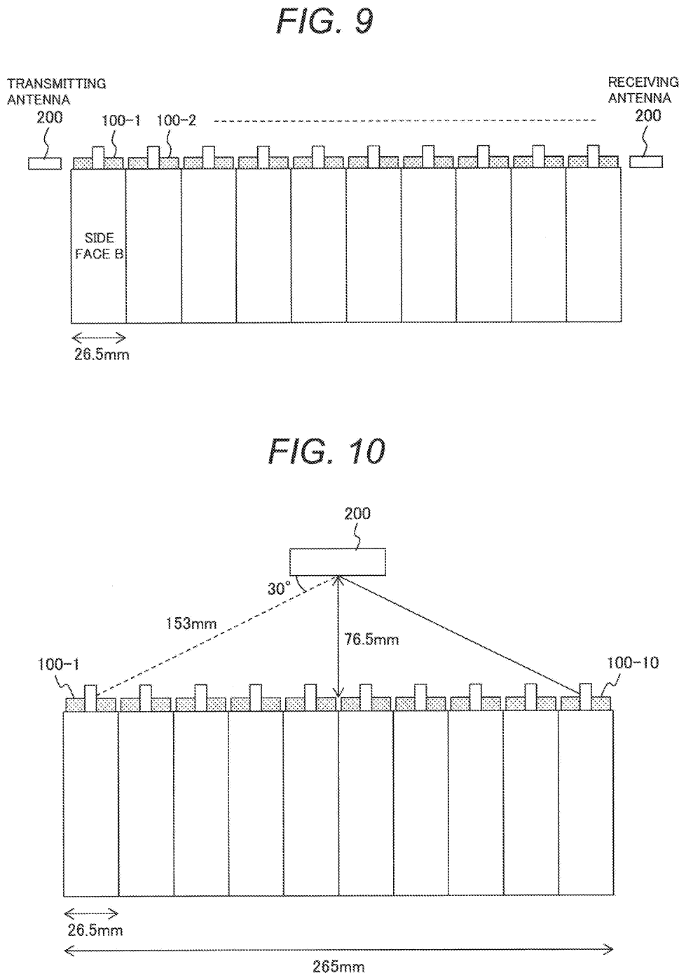

FIG. 9 is a diagram depicting ten cells arranged in light of the antenna radiation pattern. Here, it was verified that wireless communication could be performed with how much reliability. Assuming one-to-N communication, where one BC 200 communicates with plural CCs 100 as in PTL 1, the BC 200 was assumed to be placed overhead of the respective CCs 100 as shown in FIG. 10. FIG. 10 is an arrangement diagram of a wireless battery system for conventional one-to-N communication. Also, in the example of FIG. 10, the BC 200 has a commonly used dipole antenna (with a maximum absolute gain of 2.14 dBi) and the antenna is placed, intended for communication at an antenna radiation angle of 30° or more.

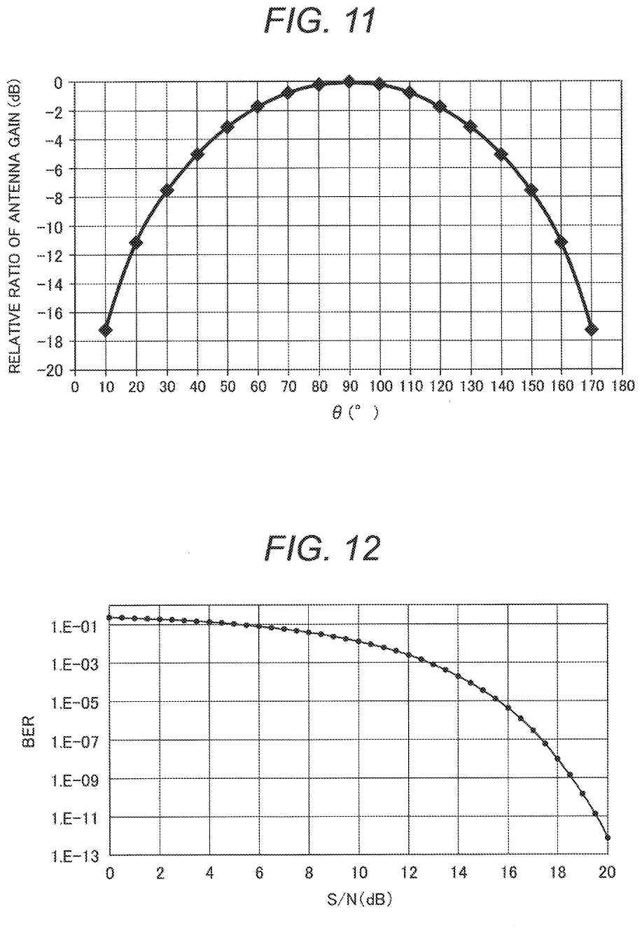

FIG. 11 is an example of a radiation pattern of the dipole antenna and, in this example, a relative ratio of the antenna gain is −7.5 dB because an angle of radiation toward CC 100-1 and CC 100-10 is 30°. The longest communication distance toward CC 100-1 and CC 100-10 is 153 mm. Given that a communication frequency is 2.45 GHz, spatial loss at a distance of 153 mm from the antenna is −24 dB according to Frith's equation (Equation 1). Also, when taking antenna directionality into account, the antenna gain (loss) is −5.36 dB (=2.14−7.5) and, combined with the spatial loss, there will be a loss of −29.36 at CC 100-1 and CC 100-10. In (Equation 1), d is distance (m) and λ is wavelength (m).

Spatial loss (dB)=20×log (4π×d/λ) (1)

On the other hand, in FIG. 9 representing the structure according to the present invention, one-to-one communication is carried out and, therefore, communication distances between BC 200 and a CC 100 and between CCs 100 are 26.5 mm which corresponds to the width between the side faces B of a cell and the spatial loss at 2.45 GHz is −8.7 dB according to (Equation 1). Also, a relative ratio depending on antenna directionality can be equal to 0 dB (see FIG. 8) and a total loss is −6.56 dB calculated by adding the dipole antenna gain of 2.14 dBi to the special loss of −8.7 dB depending on the distance. In comparison to the loss of −29.36 dB in the case of one-to-N communication, there is a loss reduction of 22.8 dB. This corresponds to an S/N improvement of 22.8 dB.

FIG. 12 represents a correlation diagram between S/N (signal to noise ratio) and BER (bit error rate) when ASK demodulation is performed. BER at S/N=0 dB is 10⁻¹ and BER at S/N=20 dB is about 10⁻¹³. This result expresses that communication reliability is improved by the present invention.

### EXAMPLE 2

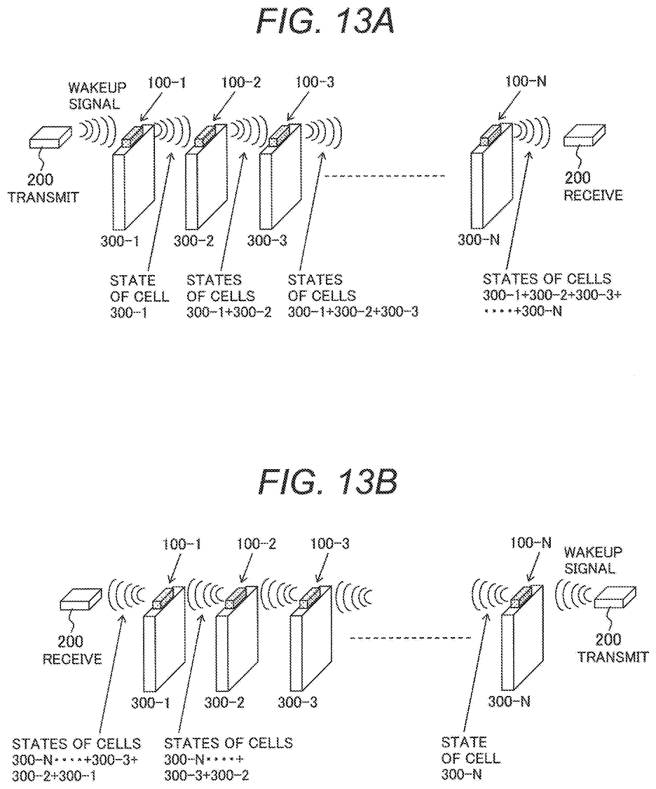

FIGS. 13A and 13B depict structural diagrams of a wireless battery system. The BC 200 communicates with the CCs 100, while alternating a CC to which to transmit and a CC from which to receive. In other words, the BC 200 transmits a wakeup signal to a CC 100 to which to transmit and receives data from a CC 100 from which to receive data after elapse of a predetermined time from the wakeup signal transmission. Then, the BC transmits a wakeup signal to the CC 100 from which to receive data and receives data from the CC 100 to which to transmit after elapse of a predetermined time from the wakeup signal transmission; in this way, the BC communicates with the CCs, while alternating the CC to which to transmit and the CC from which to receive data. For example, in FIG. 13A, the BC 200 transmits a wakeup signal to a CC 100-1 and receives data on each CC 100 from a CC 100-N. When transmitting a wakeup signal next time, the BC 200 transmits the wakeup signal to the CC 100-N and receives data on each CC 100 from the CC 100-1, as in FIG. 13B.

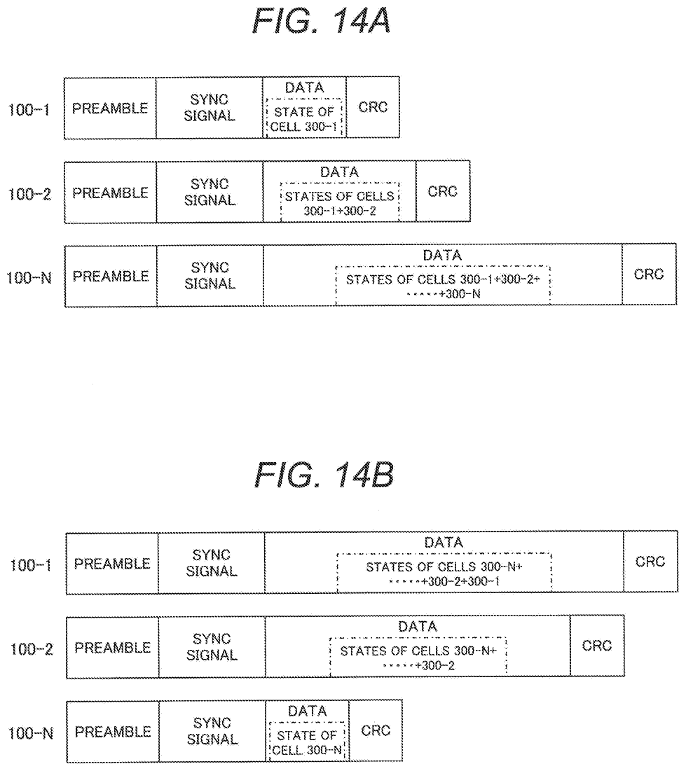

In addition, the contents of transmission data by each CC in FIGS. 13A and 13B are depicted in FIGS. 14A and 14B. For the BC 200, by communicating with the CCs 100, while alternating the CC 100 to which to transmit and the CC 100 from which to receive, it is enabled to equalize the number of pieces of transmission data by each CC as well as the time for transmission.

An advantageous effect obtained by a representative aspect of the invention that is disclosed in this application is summarized as follows. Plural cell controllers formed onto plural battery cells and a battery controller which is connected by radio with the plural cell controllers are provided, the battery controller and the plural cell controllers are connected in a daisy chain manner, and the plural cell controllers are controlled by passive reception. Thereby, highly reliable wireless communication in which wireless communication errors are reduced is feasible and the cell controllers are enabled to operate with lower power consumption by passive reception.

### REFERENCE SIGNS LIST

10 battery cell bank,

20 sensor,

30 processing unit,

31 power supply circuit,

32 A/D converter,

33 logic circuit

34 storage device

35 clock generator,

40 wireless circuit,

50 antenna,

100 CC,

200 BC,

210 wireless circuit,

220 logic circuit,

230 power supply circuit,

240 storage device,

250 antenna,

260 clock generator,

300 battery cell

1. A wireless battery system comprising:
a plurality of cell controllers connected to battery cells; and
a battery controller which is connected by radio with the plurality of cell controllers,
wherein the battery controller and the plurality of cell controllers are connected by radio in a daisy chain manner, and
wherein the plurality of cell controllers are controlled by passive reception.

2. The wireless battery system according to claim 1,
wherein the battery controller periodically transmits a wakeup signal to the plurality of cell controllers, and
wherein the battery controller passively receives battery states of the battery cells from the plurality of cell controllers.

3. The wireless battery system according to claim 1,
wherein the plurality of cell controllers operate with power of the battery cells,
wherein the plurality of cell controllers include a first cell controller, a second cell controller, and a third cell controller,
wherein upon passively receiving a wakeup signal from the battery controller or the battery states of the battery cells from the first cell controller, the second cell controller returns a reply signal indicating that it received incoming data to the battery controller or the first cell controller, and
wherein the second cell controller adds the battery states of the battery cells connected to the second controller to the incoming data and transmits the battery states to the third cell controller or the battery controller.

4. The wireless battery system according to claim 1,
wherein the plurality of cell controllers and the battery controller each have an antenna for transmitting and receiving data, and
wherein the antenna of any cell controller in the plurality of cell controllers has directionality that is made stronger toward the antenna of the cell controllers or the battery controller from which to receive data or to which to transmit data.

5. The wireless battery system according to claim 1,
wherein the plurality of cell controllers continue to transmit for a predetermined time even after completing data transmission in order to equalize time for data transmission by each cell controller in the plurality of cell controllers.

6. The wireless battery system according to claim 1,
wherein the battery controller communicates while alternating a cell controller to which to transmit data and a cell controller from which to receive data in such a way that
the battery controller transmits wakeup signal data to one of the cell controllers to which to transmit data,
upon receiving data from one of the cell controllers from which to receive data after elapse of a predetermined time from the data transmission, the battery controller transmits a wakeup signal to the one of the cell controllers from which to receive data, and
the battery controller receives data from the one of the cell controllers to which to transmit data after elapse of a predetermined time from the wakeup signal transmission.
